(19) United States
(12) Patent Application Publication
(10) Pub. No.: US 2025/0050361 A1
(43) Pub. Date: Feb. 13, 2025

(54) BACKPACK SPRAYER USER INTERFACE

(71) Applicant: Milwaukee Electric Tool Corporation, Brookfield, WI (US)

(72) Inventor: Drake J. Schlosser, Hartford, WI (US)

(21) Appl. No.: 18/794,364

(22) Filed: Aug. 5, 2024

Related U.S. Application Data
(60) Provisional application No. 63/518,680, filed on Aug. 10, 2023.

(51) Int. Cl. B05B 9/08; B05B 12/00

(52) U.S. Cl. CPC B05B 9/0861; B05B 9/0888; B05B 12/002

(57) ABSTRACT

A backpack fluid dispenser is provided. The fluid dispenser includes a backpack assembly having a fluid container, a battery compartment, a pump assembly, and a dispensing assembly for dispensing fluid from the container. The dispensing assembly includes a handheld housing having a fluid channel extending therethrough, a nozzle at an end of the fluid channel at one end of the handheld housing, and a user actuated trigger at an opposite end of the handheld housing. The pump assembly is configured to pump the fluid from the fluid container to the dispensing assembly. The fluid dispenser further includes a control assembly configured to control the pump assembly and the dispensing assembly. The control assembly includes a user interface on the dispensing assembly or detachably coupled to the backpack assembly.

### CROSS-REFERENCE TO RELATED APPLICATIONS

The present application claims priority to U.S. Provisional Patent Application Ser. No. 63/518,680 filed on Aug. 10, 2023, the disclosure of which is incorporated by reference herein in its entirety.

### FIELD

The present disclosure relates generally to a backpack sprayer, and more particularly to a portable fluid dispenser with a user interface for controlling dispensing of fluid.

### BACKGROUND

Backpack sprayers are used for dispensing different fluids in a wide variety of applications. For example, the backpack sprayers can be used to dispense water, cleaning fluid, sanitizer, weed killer, pesticide, fertilizer, paint, and other fluid to an object or a surface. In general, backpack sprayers are designed to be worn by the user by securing a tank of the sprayer against the user's back, such that the user can easily carry the tank of fluid from location to location.

However, many backpack sprayers include a user interface for controlling a pump for dispensing fluid through a user interface that is located on the back-mounted backpack assembly. Accordingly, a user typically cannot reach the user interface during use of the backpack sprayer when it is mounted on the user's back.

Accordingly, improved backpack sprayers are desired in the art. In particular, backpack sprayers which provide an improved user interface would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a backpack fluid dispenser is provided. The backpack fluid dispenser includes a fluid container, a battery compartment for receiving a battery, a pump assembly, and a dispensing assembly for dispensing fluid from the container. The dispensing assembly includes a handheld housing having a fluid channel extending therethrough along a longitudinal axis, the longitudinal axis being perpendicular to a vertical direction, a nozzle at an end of the fluid channel at one end of the handheld housing along the longitudinal axis, and a user actuated trigger at an opposite end of the handheld housing along the longitudinal axis. The pump assembly is configured to pump the fluid from the fluid container to the dispensing assembly. The fluid dispenser further includes a control assembly configured to control the pump assembly and the dispensing assembly. The control assembly includes a user interface.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a backpack sprayer in accordance with embodiments of the present disclosure;

FIG. 2 is a perspective partial view of a dispensing assembly in accordance with embodiments of the present disclosure;

FIG. 3 is a perspective partial view of a dispensing assembly in accordance with embodiments of the present disclosure;

FIG. 4 is a side cutaway view of a dispensing assembly in accordance with embodiments of the present disclosure;

FIG. 5 is a side cutaway view of a dispensing assembly in accordance with embodiments of the present disclosure;

FIG. 6 is a side cutaway view of a dispensing assembly in accordance with embodiments of the present disclosure;

FIG. 7 is a perspective view of a user wearing a backpack sprayer in accordance with embodiments of the present disclosure; and

FIG. 8 is a perspective view of a user interface in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes.” “including.” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, a backpack sprayer having a more ergonomic and accessible user interface is provided. The user interface may be incorporated into a handle of a dispensing assembly. The user interface may be couplable to a support assembly, e.g., backpack strap, of the backpack sprayer. By providing the user interface in the handle of the sprayer or coupled to the sprayer at the backpack strap or other convenient location for a user, the user interface may be more accessible to the user during use, enabling the user to modify inputs to the backpack sprayer during use.

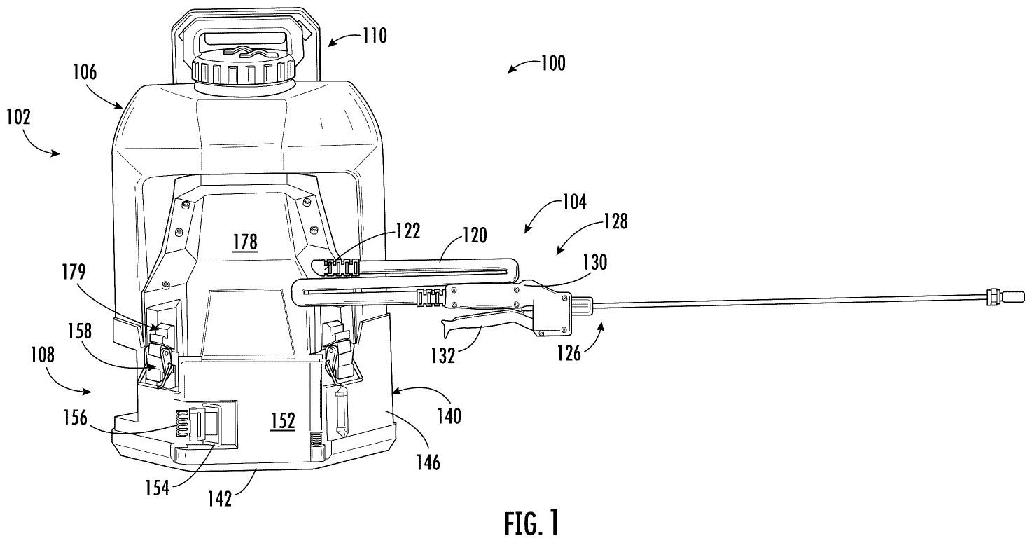

Referring now to the drawings, FIG. 1 illustrates a backpack fluid dispenser 100, also known as a backpack sprayer, comprising a backpack assembly 102 and a dispensing assembly 104. The backpack assembly 102 is configured to be supported on the user's back such that the user can easily carry the backpack sprayer 100 from location to location. The backpack assembly 102 includes a fluid container 106 and a base 108 that are supported by a support assembly 110. The base 108 includes a power source 150, e.g., a battery, a motor 172 driven by the power source 150, and a pump assembly 180 including a pump 182 driven by the motor to deliver fluid from the fluid container 106 to the dispensing assembly 104.

The fluid container 106 is a storage tank configured to carry water or other liquids for dispensing, such as but not limited to cleaning fluid, sanitizer, weed killer, pesticide, fertilizer, paint, and other fluid. The fluid container 106 may be constructed using light weight and durable materials which show excellent resistance to a wide range of chemicals, such as synthetic resin and polyester resin. The fluid container 106 may be transparent or semi-transparent, and in some aspects of the invention, a plurality of volume indicators may be provided on a side wall of the fluid container 106 to indicate the amount of fluid contained in the fluid container 106. The volume indicators may indicate the lever in gallons, liters, or other desirable measuring units.

The dispensing assembly 104 is in fluid communication with the fluid container 106 by connecting a hose 120 thereto for dispensing the fluid from the fluid container 106. A fluid channel 124 extending from the fluid container 106 may be provided with a connector 122. As illustrated in the figures, the dispensing assembly 104 can be fluidly coupled with the fluid container 106 by coupling the dispensing assembly 104 to the connector 122. The connector 122 can have any shapes, such as rectangular, round, oval, or other shapes with a cavity sufficient for gripping the hose 120 and securing it thereon. At an opposite end of the hose 120, a nozzle 126 may be provided to dispense fluid therefrom. A handheld trigger assembly 128 may be provided comprising a handle 130 and a trigger 132 configured to control the dispensing of fluid through the nozzle 126.

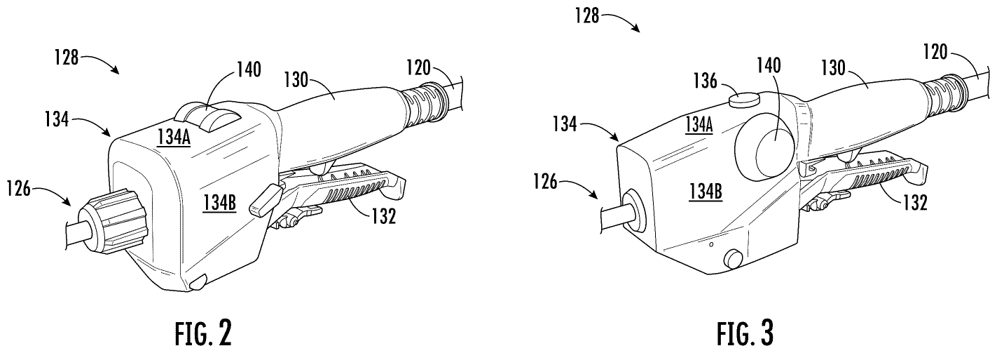

As illustrated in FIGS. 2-6, the trigger assembly 128 comprises a housing 134 coupled with the hose 120 at one end and a nozzle 126 at the opposite end. A longitudinal axis X may be formed between the ends of the trigger assembly 128. The handle 130 may be formed as part of the housing 134, and the trigger 132 may be coupled to the housing 134. A fluid channel is formed through the housing 134 from the hose 120 to the nozzle 126 in the direction of the longitudinal axis X. The handle 130 may be located above the trigger 132 in a vertical direction Y (that is perpendicular to the longitudinal direction X). Actuation of the trigger 132 may enable fluid to flow from the hose 120 to the nozzle 126, and release of the trigger 132 may cease or prevent flow of fluid to the nozzle 126.

The backpack sprayer 100 further includes a control assembly 114. The control assembly 114 is configured to control the motor and the pump assembly 180. For instance, the control assembly 114 can control the motor and pump assembly 180 to turn on and off, i.e., power delivery from the battery 150 to the motor 172.

Moreover, the control assembly 114 is configured to control a pump operating setting, e.g., the operating speed of the pump, to control the flow rate of fluid delivered from the pump. In some aspects of the invention, the control assembly 114 includes a user interface 116 and at least one printed circuit board assembly 118 (PCBA) configured to receive an input from the user interface and control the battery, motor, and pump in accordance with the received input.

The user interface 116 may include a first user input 136 configured to control power to the motor 172 from the battery 150. For instance, the first user input 136 may be an on/off input. The first user input 136 may be a button or any other suitable input, including but not limited to a pivotable lever or switch, a digital input, or the like.

The user interface 116 may further include a second user input 138 configured to control the speed of the pump 182. The second user input 138 may include a rotatable dial or knob 140 configured to be rotated by a user. The rotatable dial 140 may have the shape of a wheel with a radial dimension sufficient for the user to hold onto, and in some aspects, a radial dimension sufficient for the user to rotate with a single finger. In some aspects, the rotatable dial 140 may have a knurled rim for providing a better grip. In certain embodiments, the rotatable dial 140 may be provided in other shapes, such as a star shape, an octagonal shape, a cylinder shape, or a rectangular shape. The rotatable dial 140 can control a flow rate of the pump assembly 180. More specifically, the rotatable dial 140 may be provided with a rotary sensor 142 configured to sense a rotary position of the rotatable dial 140 and send a signal to the PCBA 118. In certain embodiments, the rotary sensor 142 is selected from a rheostat, a potentiometer, an angular position sensor, or any other devices capable of varying resistance or a voltage level in an electrical circuit. Although not illustrated in FIGS. 2-6, a plurality of electric wires are connected from the user interface 116 to the pump assembly 180 and/or battery compartment 148, e.g., forming a wired connection.

In some aspects of the present invention, rather than providing both a first user input 136 for controlling power to the pump 182 and a second user input 138 for controlling flow rate of the pump 182, a single user input may be provided. For instance, the rotatable dial 140 may be configured to control the on and off of the pump assembly 180 by opening or closing a switch of the pump assembly 180 and to control the flow rate of the pump assembly by sensing the position of the rotatable dial 140 via the rotary sensor 142.

In some aspects of the present invention, as illustrated in FIGS. 2-6, the user interface 116 may be incorporated into the trigger assembly 128. More specifically, the user interface 116 may be incorporated into the housing 134. The first user input 136 and second user input 138 may be provided on an outer portion of the housing 134 to be accessible by a user gripping the handle 130. The PCBA may be housed inside the housing 134.

FIG. 2 illustrates a trigger assembly 128 in one aspect of the present invention having a rotatable knob 140 on an upper surface 134A of the housing 134. A first user input 136, e.g., on/off button (not shown), may be provided on either side of the housing 134, or on the upper surface 134A of the housing 134.

FIG. 3 illustrates a trigger assembly 128 in one aspect of the present invention having a rotatable knob 140 on a side surface 134B of the housing 134. A first user input 136, e.g., on/off button (not shown), may be provided on the upper surface 134A of the housing 134. For instance, as shown in FIG. 3, the rotatable dial 140 may be provided on a left side surface 134B of the housing 134 when the handle 130 is held by a user such that, if the user holds the handle with their right hand, the user may operate the rotatable dial with their right thumb. Of course, although not illustrated, the rotatable dial 140 could also be positioned on a right side surface 134B of the housing 134.

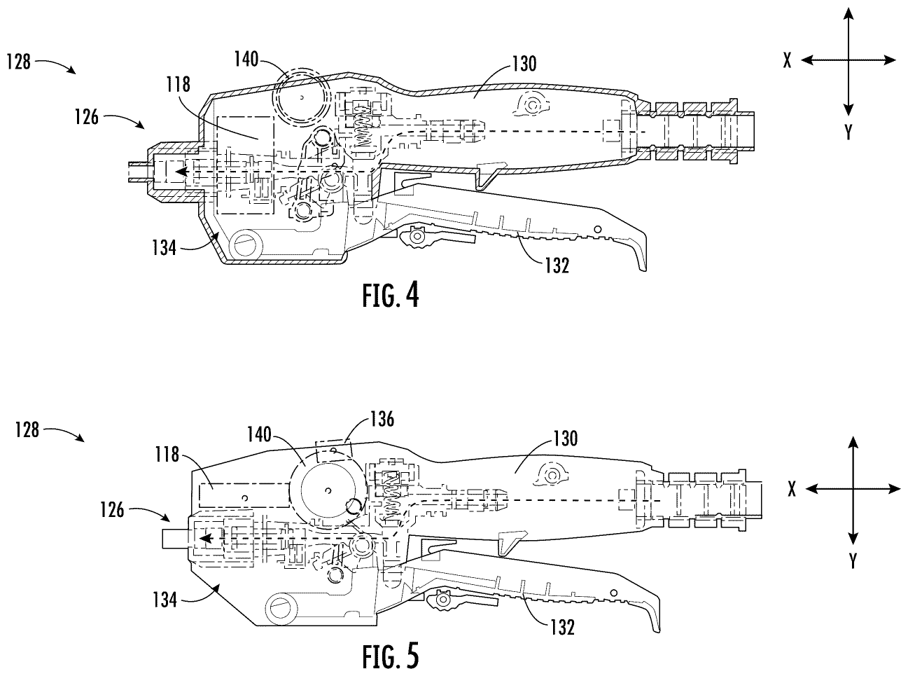

FIGS. 4-6 illustrate various possible orientations of the PCBA 118 inside the housing 134 and relative to the fluid channel 133 and nozzle 126 in accordance with aspects of the present invention.

FIG. 4 illustrates a trigger assembly 128 including a user interface 116 having a PCBA 118 that extends adjacent to the flow channel 133 in the longitudinal X direction and disposed within the housing 134. In other words, the PCBA 118 may extend above and below the fluid channel 133 in a vertical Y direction and be spaced apart from the fluid channel 133 to the right or left side of the fluid channel 133 within the housing 134. For instance, a longest dimension of the PCBA 118 may extend in the vertical direction Y. A shortest dimension (not shown) of the PCBA 118 may extend in a direction perpendicular to both the longitudinal direction X and the vertical direction Y, i.e., in the right to left direction of the trigger assembly 128.

FIG. 5 illustrates a trigger assembly 128 including a user interface 116 having a PCBA 118 that is located above the fluid channel 133 in the vertical Y direction and disposed within the housing 134. For instance, the PCBA 118 may be located above the nozzle 126 in the Y direction. A shortest dimension of the PCBA 118 may extend in the vertical direction Y.

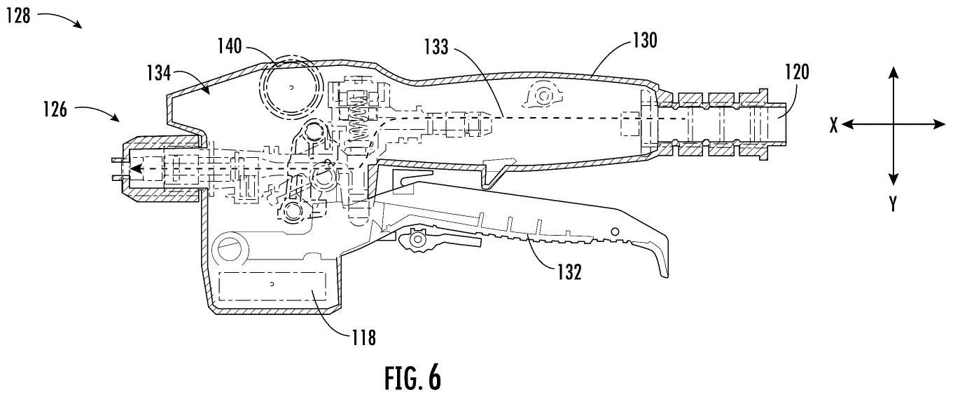

FIG. 6 illustrates a trigger assembly 128 including a user interface 116 having a PCBA 118 that is located below the fluid channel 133 in the Y-direction and disposed within the housing 134. For instance, the PCBA 118 may be located below the nozzle 126 in the Y direction. A shortest dimension of the PCBA 118 may extend in the vertical direction Y.

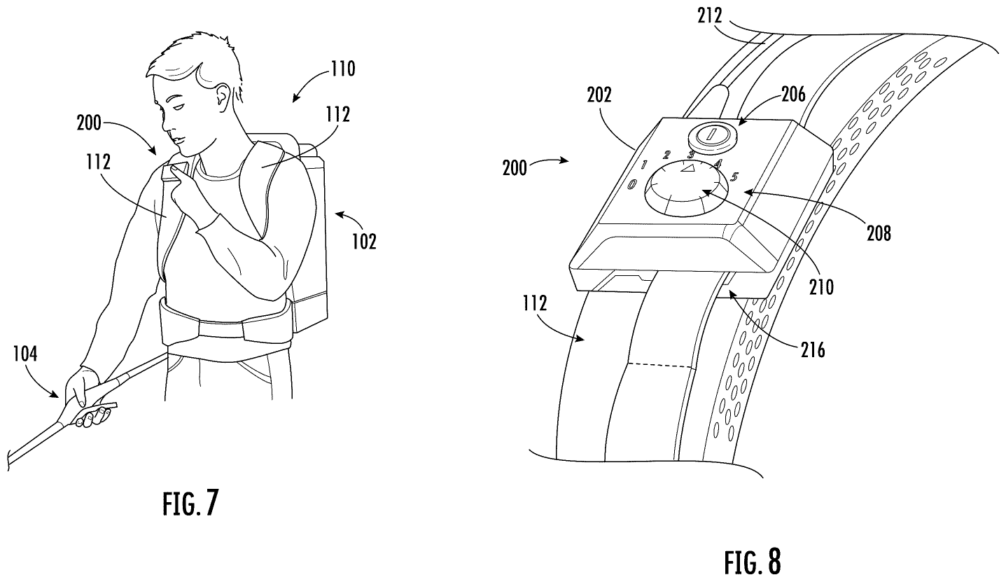

Turning to FIGS. 7 and 8, the support assembly 110 of the backpack sprayer 100 is shown in more detail. The support assembly 110 may include one or more shoulder straps 112 secured to the fluid container 106 and/or the base 108. For instance, the fluid container 106 and/or the base 108 may include one or more strap harnesses at which the shoulder strap(s) 112 may be attached. It is apparent that the shoulder strap(s) 112 may be attached to any number of strap harnesses, which may be formed integrally and molded as a part of the fluid container 106 and/or base 108. Alternatively, the strap harness may also be glued, bonded, or fastened to the fluid container 106 and/or base 108. The support assembly 110 may further include a sternum strap (not shown) attached to two shoulder straps 112 and configured to extend across the chest of the user, thus the sternum strap can keep the backpack sprayer 100 tightly in place relative to the user's body and prevent the shoulder straps 112 from sliding off the shoulders of the user.

In some aspects of the present invention, the user interface 116 may include a standalone user interface housing 200. The user interface housing 200 may include a housing body 202. A first user input 204 and a second user input 206 may be provided on an outer side of the housing body 202. The first user input 204 may be analogous to the first user input 136 and function as an on and off button. The second user input 206 may be analogous to the second user input 138 and may control the flow rate of the pump 182, e.g., by a rotatable knob 210. A PCBA (not shown) may be enclosed within the housing body 202. A cable 212 may be provided to carry electrical wires from the PCBA of the user interface 116 to the base 108.

The standalone user interface housing 200 may be adapted to be selectably placed by a user, e.g., to position the user interface 116 for ease of access during use of the backpack sprayer 100. Advantageously, the standalone user interface housing 200 may be couplable with the backpack straps 112 of the support assembly 110. As illustrated in FIG. 7, the standalone user interface housing 200 may be coupled to a front side of a backpack strap 112 relative to the user's body such that the user may adjust the user inputs 206, 208 when the backpack sprayer is in use.

In some aspects of the invention, the standalone user interface housing 200 may include a coupling member 214. The coupling member 214 may be a clip, button, or other suitable fastener configured to detachably couple the standalone user interface housing 200 to a backpack strap 112, a user's garment, or other location. For instance, FIG. 8 illustrates a clip 216 coupled to the housing body 202. A hinge (not shown) may be provided between the housing body 202 and the clip 216 to enable the clip to be opened and closed relative to the

Further aspects of the invention are provided by one or more of the following embodiments:

A backpack fluid dispenser includes a fluid container, a battery compartment for receiving a battery, a pump assembly, and a dispensing assembly for dispensing fluid from the container. The dispensing assembly includes a handheld housing having a fluid channel extending therethrough along a longitudinal axis, the longitudinal axis being perpendicular to a vertical direction, a nozzle at an end of the fluid channel at one end of the handheld housing along the longitudinal axis, and a user actuated trigger at an opposite end of the handheld housing along the longitudinal axis. The pump assembly is configured to pump the fluid from the fluid container to the dispensing assembly. The fluid dispenser further includes a control assembly configured to control the pump assembly and the dispensing assembly. The control assembly includes a user interface.

The backpack fluid dispenser of any one or more of the embodiments, wherein the user interface comprises one or more buttons, rotary dials or knobs, or digital inputs.

The backpack fluid dispenser of any one or more of the embodiments, the control assembly comprising a printed circuit board assembly (PCBA), the PCBA being disposed within the handheld housing of the dispensing assembly.

The backpack fluid dispenser of any one or more of the embodiments, the PCBA having a shortest dimension extending in the vertical direction.

The backpack fluid dispenser of any one or more of the embodiments, the PCBA being disposed above the nozzle in the vertical direction.

The backpack fluid dispenser of any one or more of the embodiments, the PCBA being disposed below the nozzle in the vertical direction.

The backpack fluid dispenser of any one or more of the embodiments, the PCBA being disposed to a side of the nozzle along the longitudinal axis.

The backpack fluid dispenser of any one or more of the embodiments, a shortest dimension of the PCBA being oriented perpendicular to the vertical direction and to the longitudinal axis.

The backpack fluid dispenser of any one or more of the embodiments further comprising a support assembly, and a user interface housing configured to be coupled the support assembly.

The backpack fluid dispenser of any one or more of the embodiments, wherein the user interface housing is detachably coupled to the support assembly.

The backpack fluid dispenser of any one or more of the embodiments, wherein the support assembly comprises a strap, wherein the user interface housing is configured to be coupled to the strap.

The backpack fluid dispenser of any one or more of the embodiments, the user interface housing having one or more buttons, rotary dials or knobs, or digital inputs.

The backpack fluid dispenser of any one or more of the embodiments, the control assembly comprising a printed circuit board assembly (PCBA) disposed in the user interface housing, the control assembly further comprising a wired connection to the pump assembly.

An apparatus as shown and described in one or more embodiments herein.

A system configured to operate in accordance with any one or more of the embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A backpack fluid dispenser comprising: a fluid container; a battery compartment for receiving a battery; a pump assembly; and a dispensing assembly for dispensing fluid from the container, the dispensing assembly comprising a handheld housing having a fluid channel extending therethrough along a longitudinal axis, the longitudinal axis being perpendicular to a vertical direction, a nozzle at an end of the fluid channel at one end of the handheld housing along the longitudinal axis, and a user actuated trigger at an opposite end of the handheld housing along the longitudinal axis; wherein the pump assembly is configured to pump the fluid from the fluid container to the dispensing assembly; further comprising a control assembly configured to control the pump assembly and the dispensing assembly; the control assembly including a user interface.

2. The backpack fluid dispenser of claim 1, wherein the user interface comprises one or more buttons, rotary dials or knobs, or digital inputs.

3. The backpack fluid dispenser of claim 1, the control assembly comprising a printed circuit board assembly (PCBA), the PCBA being disposed within the handheld housing of the dispensing assembly.

4. The backpack fluid dispenser of claim 3, the PCBA having a shortest dimension extending in the vertical direction.

5. The backpack fluid dispenser of claim 4, the PCBA being disposed above the nozzle in the vertical direction.

6. The backpack fluid dispenser of claim 4, the PCBA being disposed below the nozzle in the vertical direction.

7. The backpack fluid dispenser of claim 3, the PCBA being disposed to a side of the nozzle along the longitudinal axis.

8. The backpack fluid dispenser of claim 7, a shortest dimension of the PCBA being oriented perpendicular to the vertical direction and to the longitudinal axis.

9. The backpack fluid dispenser of claim 1 further comprising a support assembly, and a user interface housing configured to be coupled the support assembly.

10. The backpack fluid dispenser of claim 9, wherein the user interface housing is detachably coupled to the support assembly.

11. The backpack fluid dispenser of claim 9, wherein the support assembly comprises a strap, wherein the user interface housing is configured to be coupled to the strap.

12. The backpack fluid dispenser of claim 9, the user interface housing having one or more buttons, rotary dials or knobs, or digital inputs.

13. The backpack fluid dispenser of claim 9, the control assembly comprising a printed circuit board assembly (PCBA) disposed in the user interface housing, the control assembly further comprising a wired connection to the pump assembly.
